(19) United States
(12) Patent Application Publication
(10) Pub. No.: US 2026/0030126 A1
(43) Pub. Date: Jan. 29, 2026

(54) PROCESSING METHOD, PROCESSING APPARATUS, AND ELECTRONIC DEVICE

(71) Applicant: Lenovo (Beijing) Limited, Beijing (CN)

(72) Inventors: Yunyong YAO, Beijing (CN); Shurui ZHANG, Beijing (CN)

(21) Appl. No.: 19/277,705

(22) Filed: Jul. 23, 2025

(30) Foreign Application Priority Data
Jul. 26, 2024 (CN) 202411018000.4

(51) Int. Cl. G06F 11/22; G06F 13/40

(52) U.S. Cl. CPC G06F 11/2284; G06F 13/4081

(57) ABSTRACT

A processing method includes performing, by a first firmware management module, a target operation for assigning communication channels to target hardware interfaces of an electronic device, respectively, to obtain a communication channel assignment parameter generated for each of the target hardware interfaces, sending, by the first firmware management module, the communication channel assignment parameter generated for each of the target hardware interfaces to a second system management module of the electronic device, so that the second system management module outputs corresponding function numbers for the target hardware interfaces based on corresponding communication channel assignment parameters, respectively, and obtaining, by the first firmware management module, the function numbers output by the second system management module for the target hardware interfaces, each function number corresponding to a target hardware interface.

### CROSS-REFERENCES TO RELATED APPLICATION

The present disclosure claims priority to Chinese Patent Application No. 202411018000.4 filed on Jul. 26, 2024, the entire content of which is incorporated herein by reference.

### FIELD OF TECHNOLOGY

The present disclosure relates to the computer technology field and, more specifically, to a processing method, a processing apparatus, and an electronic device.

### BACKGROUND

Hot plugging refers to “power-on insertion and removal.” The hot plugging function allows a user to remove and replace a damaged hard drive, power supply, or card without powering off the system and cutting off the power supply to improve the timely recovery capability of the system for an error/disaster.

To ensure the hot plugging function of an AMD NVME (NVM Express) interface to be normal, a function number assigned by a UEFI (unified extensible firmware interface) for a root port of the NVME interface must be the same as a function number assigned by a SMU (system management unit) of CPU (central processing unit) for the root port of the NVME interface. Otherwise, the hot plugging function of the NVME interface is unstable.

Currently, assigning, by the UEFI, the function number for the root port of the NVME interface includes generating and assigning a corresponding function number for the root port of the NVME interface according to a rule of calculating, by the CPU SMU, the function number provided by AMD. However, the rule of calculating, by the CPU SMU, the function number is complex. The UEFI can hardly calculate and generate the function number with 100% accuracy. Thus, the function number assigned to the root port of the NVME interface may not be ensured to be the same as the function number assigned by the SMU of the CPU. Thus, the hot plugging function of the NVME interface can be unstable.

### SUMMARY

One aspect of this disclosure provides a processing method. The method includes performing, by a first firmware management module, a target operation for assigning communication channels to target hardware interfaces of an electronic device, respectively, to obtain a communication channel assignment parameter generated for each of the target hardware interfaces, sending, by the first firmware management module, the communication channel assignment parameter generated for each of the target hardware interfaces to a second system management module of the electronic device, so that the second system management module outputs corresponding function numbers for the target hardware interfaces based on corresponding communication channel assignment parameters, respectively, and obtaining, by the first firmware management module, the function numbers output by the second system management module for the target hardware interfaces, each function number corresponding to a target hardware interface.

Another aspect of this disclosure provides a processing apparatus including a assignment unit, a transmission unit, and an acquisition unit. The assignment unit is configured to perform a target operation for assigning communication channels to target hardware interfaces of an electronic device, respectively, to obtain a communication channel assignment parameter generated for each of the target hardware interfaces. The transmission unit is configured to send the communication channel assignment parameter generated for each of the target hardware interfaces to a second system management module of the electronic device, so that the second system management module outputs corresponding function numbers for the target hardware interfaces based on corresponding communication channel assignment parameters, respectively. The acquisition unit is configured to obtain the function numbers output by the second system management module for the target hardware interfaces, each function number corresponding to a target hardware interface.

Another aspect of this disclosure provides an electronic device, including a first firmware management module and a second system management module. The first firmware management module is configured to provide an interface between an operating system of the electronic device and hardware. The second system management module has a system management function. The first firmware management module is further configured to perform a target operation for assigning communication channels to target hardware interfaces of an electronic device, respectively, to obtain a communication channel assignment parameter generated for each of the target hardware interfaces, send the communication channel assignment parameter generated for each of the target hardware interfaces to a second system management module of the electronic device, so that the second system management module outputs corresponding function numbers for the target hardware interfaces based on corresponding communication channel assignment parameters, respectively, and obtain the function numbers output by the second system management module for the target hardware interfaces, each function number corresponding to a target hardware interface.

### BRIEF DESCRIPTION OF THE DRAWINGS

In combination with accompanying drawings and with reference to the following description of embodiments, the above and other features, advantages and aspects of the embodiments of the present disclosure will become more apparent. Throughout the drawings, a same or similar reference number represents a same or similar element. It should be understood that the drawings are schematic and that an element are not necessarily drawn to scale.

FIG. 1 is a schematic flowchart of a processing method according to some embodiments of the present disclosure.

FIG. 2 is a schematic flowchart of another processing method according to some embodiments of the present disclosure.

FIG. 3 is a schematic flowchart of another processing method according to some embodiments of the present disclosure.

FIG. 4 is a schematic structural diagram of a processing apparatus according to some embodiments of the present disclosure.

FIG. 5 is a schematic structural diagram of an electronic device according to some embodiments of the present disclosure.

### DETAILED DESCRIPTION

In connection with the accompanying drawings of embodiments of the present disclosure, technical solutions of the present disclosure are described in detail. Apparently, the described embodiments are merely some embodiments of the present disclosure not all embodiments. Based on embodiments of the present disclosure, all other embodiments obtained by those of ordinary skill in the art without any creative effort are within the scope of the present disclosure.

Embodiments of the present disclosure provide a processing method, a processing apparatus, and an electronic device, which can be configured to ensure the stability of the hot plugging function of a target hardware interface, such as an NVME interface. The disclosed processing method can be applied to, but is not limited to, electronic devices under various general or special computing apparatus environments or configurations, for example, a personal computer, a server computer, a handheld or portable device, a tablet device, a multiprocessor apparatus, and so on.

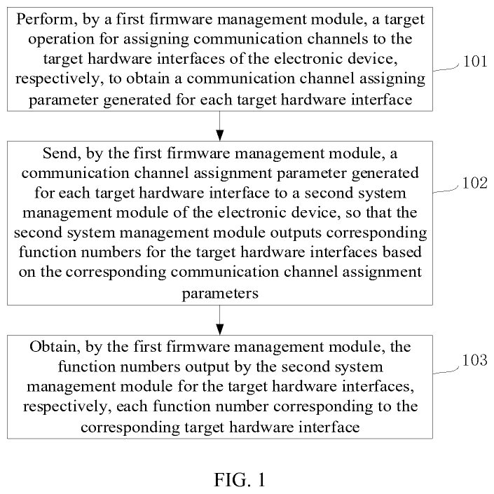

Referring to the flowchart shown in FIG. 1, the processing method of embodiments of the present disclosure includes at least the following processing steps.

At 101, a first firmware management module performs a target operation for assigning communication channels to the target hardware interfaces of the electronic device, respectively, to obtain a communication channel assigning parameter generated for each target hardware interface.

In some embodiments, the first firmware management module is a Unified Extensible Firmware Interface (UEFI) of the electronic device. The target hardware interface is the Non-Volatile Memory Express (NVME) interface of the electronic device, for example, an AMD NVME interface.

In some embodiments, the target operation can include, e.g., a bifurcation operation, which is performed by UEFI to assign communication channels to NVME interfaces of the electronic device, respectively.

The first firmware management module, such as a UEFI, can be configured to assign a parameter to a communication channel generated for each target hardware interface through the target operation. The parameter can include at least one of a processor identifier or a communication channel identifier.

In this step, the first firmware management module can perform the target operation for assigning communication channels to target hardware interfaces of the electronic device, respectively, during a preset stage in the power-on self-test process of the electronic device. The preset stage can be earlier than a Driver Execution Environment (DXE) stage in the power-on self-test process.

When the first firmware management module is a UEFI and the target hardware interface is an NVME interface, the UEFI can obtain at least one of the processor identifier and the communication channel identifier generated for each NVME interface by performing the target operation, e.g., the bifurcation operation, to assign the communication channels to the NVME interfaces of the electronic device, respectively.

The processor identifier generated for each NVME interface can be used to indicate a processor connected to each NVME interface based on the assigned communication channel, such as a connected CPU (Central Processing Unit).

In some embodiments, the target operation can be used to assign the communication channels to the NVME interfaces on a preset connection line. The preset connection line can include, but is not limited to, a PCIE (Peripheral Component Interconnect Express) connection line.

The communication channel identifier generated for each NVME interface can be used to indicate the communication channel assigned to each NVME interface on the preset connection line.

In some embodiments, the communication channel identifier can further include a communication channel start number and a communication channel end number. The communication channel start number and the communication channel end number generated for each NVME interface can be used to indicate a start communication channel and an end communication channel assigned to each NVME interface on the preset connection line, respectively. The start communication channel and the end communication channel can be indicated by the communication channel start number and the communication channel end number corresponding to each NVME interface, and channel numbers corresponding to numbers between the start number and the end number can be the communication channels assigned to the NVME interface.

However, in actual applications, the communication channel identifier generated for each NVME interface can also include a communication channel number enumeration result of the communication channels assigned to each NVME interface. As long as the communication channel identifier can effectively identify the communication channels assigned to each NVME interface, the communication channel identifier is within the scope of embodiments of the present disclosure.

At 102, the first firmware management module sends a communication channel assignment parameter generated for each target hardware interface to a second system management module of the electronic device, so that the second system management module outputs corresponding function numbers for the target hardware interfaces based on the corresponding communication channel assignment parameters.

After obtaining the communication channel assignment parameters generated for each target hardware interface by performing the target operation, the first firmware management module can send the communication channel assignment parameters to the second system management module of the electronic device. After receiving the communication channel assignment parameters corresponding to the target hardware interfaces, the second system management module can output corresponding function numbers for the target hardware interfaces based on the corresponding communication channel assignment parameters.

The second system management module can generate a corresponding function number for each target hardware interface using a generation rule according to the communication channel assignment parameters corresponding to each target hardware interface, or directly assign (i.e., assign directly without performing generation calculation) a corresponding function number for each target hardware interface using an assignment rule, which is not limited. Regardless of whether the function number is obtained based on a generation method or based on a direct assignment method, the function number can be considered a function number assigned by the second system management module for the target hardware interface.

In some embodiments, the second system management module can be an SMU (System Management Unit) within the CPU of the electronic device.

In this step, the UEFI can send a communication channel assignment parameter, such as at least one of the processor identifier or communication channel identifier, generated for each NVME interface to the SMU of the CPU of the electronic device. Thus, the SMU can output the corresponding function numbers for the NVME interfaces, respectively, based on the received communication channel assignment parameters.

In some embodiments, the SMU can generate and output a corresponding function number for the root port of each NVME interface through a preset generation rule according to a communication channel assignment parameter, such as at least one of the processor identifier or communication channel identifier. In some embodiments, the SMU can take the communication channel assignment parameter, such as at least one of the processor identifier or communication channel identifier, corresponding to each NVME interface as the basis for generating the function number for the root port of the NVME interface, and generate a corresponding function number for the NVME interface using the corresponding generation rule, e.g., generation algorithm.

For example, the communication channel assignment parameter corresponding to each NVME interface can include the processor identifier, the communication channel start number, and the communication channel end number. The UEFI can calculate and generate the corresponding function number for each NVME interface using the generation rule, such as the generation algorithm, according to the three parameters corresponding to each NVME interface, i.e., the processor identifier, the communication channel start number, and the communication channel end number.

In some other embodiments, for each NVME interface receiving the corresponding communication channel assignment parameter, the SMU can also directly assign, rather than generate, a corresponding function number for each NVME interface according to an assignment rule. For example, the SMU can pre-store a plurality of function numbers, and after receiving the communication channel assignment parameters of the NVME interfaces, read a corresponding quantity of function numbers sequentially from the plurality of pre-stored function numbers, assign the read function numbers as the function numbers to the NVME interfaces in a one-to-one correspondence, and output an assignment result.

The input data of the second system management module can include the communication channel assignment parameters corresponding to the target hardware interfaces. The output data can include the input communication channel assignment parameters and the determined function numbers. For example, the input data of the SMU can include the processor identifier, the communication channel start number, and the communication channel end number corresponding to each NVME interface. The output parameters can include the processor identifier, the communication channel start number, the communication channel end number, and the function number generated or directly assigned for each NVME interface.

Furthermore, in the output data, the function number output by the second system management module for each target hardware interface can be associated with the communication channel assignment parameters corresponding to that target hardware interface. Thus, the function number generated or directly assigned for each target hardware interface can correspond to the target hardware interface.

For example, in the output data of the SMU, the function number generated or directly assigned by the SMU for each NVME interface can be associated with the processor identifier, the communication channel start number, and the communication channel end number corresponding to the NVME interface. Thus, the function number generated or directly assigned for each NVME interface can correspond to the NVME interface.

At 103, the first firmware management module obtains the function numbers output by the second system management module for the target hardware interfaces, respectively. Each function number corresponds to the corresponding target hardware interface.

In some embodiments, the second system management module can send the output data for the target hardware interfaces to the first firmware management module. For each target hardware interface, the first firmware management module can match at least a part of the communication channel assignment parameters corresponding to the target hardware interface with the output data when the second system management module outputs the function numbers for the target hardware interfaces, and obtain and use a function number in the output data that match the at least a part of the communication channel assignment parameters as the function number of that target hardware interface.

For example, the first firmware management module can be a UEFI, and the second system management module can be a SMU. For example, the SMU can generate the function number or directly assign the output data for each NVME interface. For example, the processor identifier, communication channel start number, communication channel end number, and the function number can be sent to the UEFI, e.g., a register in the UEFI. The UEFI can match the function number corresponding to each NVME interface from the stored data in the register using the communication channel assignment parameters, such as the processor identifier, the communication channel start number, the communication channel end number, etc., as indices.

In practical applications, in some other embodiments, the second system management module can also directly send the output data to a corresponding buffer area outside the first firmware management module. The first firmware management module can determine and obtain the function number corresponding to each target hardware interface from the buffer area by using the communication channel assignment parameters corresponding to each target hardware interface as indices.

Based on obtaining the function number corresponding to each target hardware interface, subsequently, the first firmware management module can, based on the function number corresponding to each target hardware interface, perform necessary applications in the electronic device, such as applications related to the hot plugging of the target hardware interface such as the NVME interface.

In some embodiments, the function number assigned by the UEFI for the root port of the NVME interface can be intended to allow the UEFI to perform the related applications based on the function number corresponding to the root port of the NVME interface, e.g., the applications related to the hot plugging of the NVME interface. To ensure that the hot plugging function of the AMD NVME interface is normal, the function number of the root port of the NVME interface used by the UEFI and the function number assigned by the SMU for the root port of the NVME interface may essentially be the same. The inventor discovers that the electronic device does not force to require the UEFI to assign the function number for the root port of the NVME interface, as long as the UEFI can obtain the function numbers of the root ports of the NVME interfaces, and the obtained function numbers can be ensured to be the same as the function numbers assigned by the SMU for the root ports of the NVME interfaces.

Based on this, in the processing method of embodiments of the present disclosure, the first firmware management module, such as the UEFI, may no longer perform the operation of generating the function numbers for the root ports of the target hardware interfaces, such as the NVME interfaces. Instead, the interaction logic between the first firmware management module, such as the UEFI, and the second system management module, such as the SMU, can be designed. The first firmware management module, such as the UEFI, can directly obtain the function number, and the second system management module, such as the SMU, can assign the function number to the target hardware interface. Then, the function numbers of the target hardware interfaces obtained by the first firmware management module, such as the UEFI, can be ensured to be the same as the function numbers assigned by the second system management module, such as the SMU, for the target hardware interfaces. Accordingly, the stability of the hot plugging function of the target hardware interface, such as the NVME interface, can be ensured.

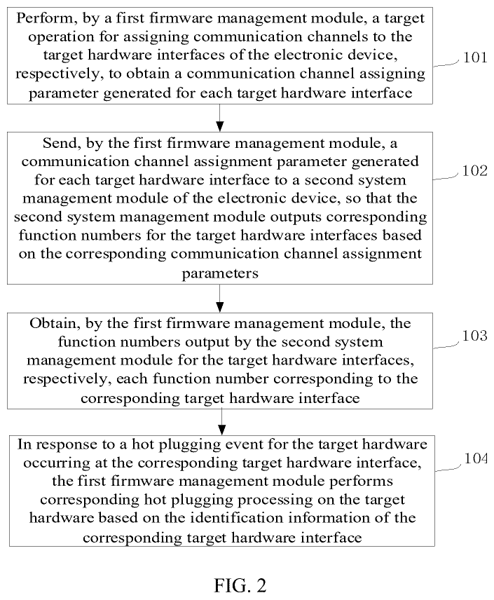

In some embodiments, referring to the flowchart of the processing method shown in FIG. 2, the processing method of the present disclosure further includes the following steps after step 103.

At 104, in response to a hot plugging event for the target hardware occurring at the corresponding target hardware interface, the first firmware management module performs corresponding hot plugging processing on the target hardware based on the identification information of the corresponding target hardware interface.

The identification information of the corresponding target hardware interface can be generated based on the function number of the corresponding target hardware interface.

The type of the target hardware can match the target hardware interface. When the target hardware interface is an NVME interface, the target hardware can be an NVME device such as an NVME disk.

For example, the first firmware management module can be a UEFI, and the target hardware interface can be an NVME interface. The UEFI can generate the identifier of the NVME interface based on the function number corresponding to the root port of the NVME interface. In some embodiments, the function number corresponding to the root port of the NVME interface can be a component of an identification string of the NVME interface (e.g., as a sub-segment of the identification string of the NVME interface) to generate a corresponding identifier for the NVME interface.

Based on this, the UEFI can detect the hot plugging event of the NVME interface, and in response to detecting the hot plugging event for the NVME device at the corresponding NVME interface, perform the hot plugging processing corresponding to the hot plugging event on the NVME device based on the identification information of the NVME interface.

For example, if an NVME disk is detected to be inserted into an NVME interface, the inserted NVME disk can be recognized based on the identification information of the NVME interface, and a corresponding disk mark can be displayed on the disk interface of the electronic device. If an NVME disk is detected to be removed from an NVME interface, the removed NVME disk can be recognized based on the identification information of the NVME interface, and the disk mark of the NVME disk can be deleted from the disk interface of the electronic device.

In the present disclosure, the interaction logic between the first firmware management module, such as the UEFI, and the second system management module, such as the SMU, can be designed. Then, the function number can be directly obtained from the first firmware management module, such as the UEFI, and the second system management module, such as the SMU, can be configured to assign the function number to the target hardware interface. Thus, the function numbers of the target hardware interfaces obtained by the first firmware management module, such as the UEFI, can be ensured to be the same as the function numbers assigned by the second system management module, such as the SMU, to the target hardware interfaces. Correspondingly, the stability of the hot plugging function of the target hardware interface, such as the NVME interface, can be ensured. When a hot plugging event occurs at the target hardware interface, such as the NVME interface, an abnormal event that cannot be recognized may not occur.

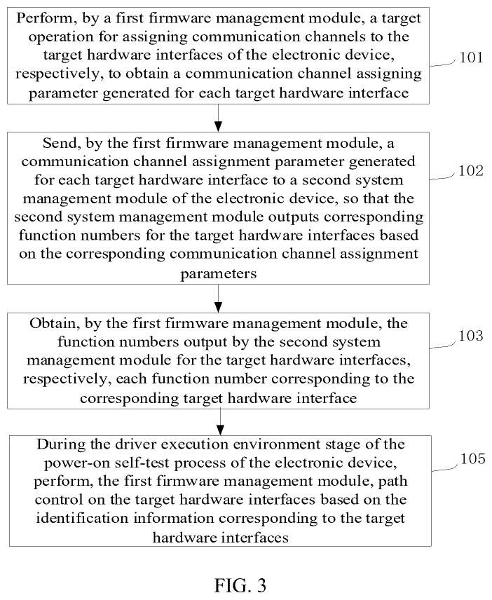

In some embodiments, referring to the flowchart of the processing method shown in FIG. 3, the processing method of the present disclosure, after step 103, further includes the following process.

At 105, during the driver execution environment stage of the power-on self-test process of the electronic device, the first firmware management module performs path control on the target hardware interfaces based on the identification information corresponding to the target hardware interfaces.

The identification information corresponding to each target hardware interface can be generated based on the function number of the target hardware interface.

When the first firmware management module is the UEFI, and the target hardware interface is the NVME interface, the UEFI can generate an identifier for the NVME interface based on the function number corresponding to the root port of the NVME interface. For the generation process, references can be made to the description of embodiments above, which is not repeated.

In some embodiments, during the driver execution environment stage of the power-on self-test process of the electronic device, the UEFI can perform the path control on the NVME interfaces based on the identification information corresponding to the NVME interfaces. By performing the path control on the NVME interfaces, the hardware, such as an NVME disk, mounted on the NVME interfaces can be controlled.

In the power-on self-test process of the electronic device of embodiments of the present disclosure, the UEFI can perform the path control on the NVME interfaces based on the identification information corresponding to the NVME interfaces. Thus, when the user uses the electronic device, the user can quickly locate the required file or directory. Meanwhile, the safety of the file can be protected.

In some embodiments, the processing method of the present disclosure can further include, before step 101, the first firmware management module obtaining the attributes of each hardware interface on the electronic device to trigger the target operation for the target hardware interfaces having the target attribute.

In some embodiments, the attribute of the hardware interface can include the interface type of the hardware interface. The target attribute can be the target interface type of the hardware interface. In some embodiments, the target interface type can be set to NVME.

For example, the hardware interface can be a hard disk/disk interface. In some embodiments, during the preset stage of the power-on self-test process of the electronic device, the UEFI can first obtain the interface type of the hard drive/disk interfaces, such as NVME, SATA (Serial ATA), etc. The target operation can be triggered only for the hard drive/disk interface of the NVME type. Based on the target operation and the subsequent steps (e.g., steps 102 and 103) of the target operation, when the UEFI obtain the function number output by the SMU for the root port of the NVME interface, the target operation may not be necessarily triggered for an interface of another type, such as SATA interface. Accordingly, the subsequent steps (e.g., steps 102 and 103) of the target operation may not need to be performed.

The interface of the other type, such as a SATA interface, can be managed according to a management strategy adapted to the interface of the other type.

In addition, the UEFI can also store attribute information such as type and slot number of the hardware interface, such as the hard drive/disk interface. Thus, when the user wants to query the attributes of the hardware interface, the user can easily review.

In some embodiments, the first firmware management module, such as the UEFI, can obtain the attributes of the hardware interfaces of the electronic device, and the target operation can be triggered for the target hardware interface having the target attribute. A non-sense operation performed on a hardware interface having a non-target attribute can be avoided. Thus, the processing efficiency can be further improved, and the time consumption can be lowered.

Corresponding to the above processing method, embodiments of the present disclosure further provide a processing apparatus. The structure of the processing apparatus is shown in FIG. 4. The processing apparatus includes an assignment unit 401, a transmission unit 402, and an acquisition unit 403.

The assignment unit 401 can be configured to perform the target operation of assigning the communication channels to the target hardware interfaces of the electronic device, and obtain the communication channel assignment parameter generated for each target hardware interface.

The transmission unit 402 can be configured to send the communication channel assignment parameter generated for each hardware interface to the second system management module of the electronic device, such that the second system management module outputs the corresponding function numbers to the target hardware interfaces based on the corresponding communication channel assignment parameters, respectively.

The acquisition unit 403 can be configured to obtain the function numbers generated and output by the second system management module for the target hardware interfaces. Each function number corresponds to a target hardware interface.

In some embodiments, the assignment unit 401 can be configured to perform the target operation for assigning the communication channels to the Non-Volatile Memory Host Controller Interfaces of the electronic device, respectively, and obtain at least one of the processor identifier or the communication channel identifier generated for each Non-Volatile Memory Host Controller Interface.

The processor identifier generated for each Non-Volatile Memory Host Controller Interface can be used to indicate the processor connected to each Non-Volatile Memory Host Controller Interface via the assigned communication channel. The target operation can be used to assign communication channels to the Non-Volatile Memory Host Controller Interfaces on a preset connection line. The communication channel identifier generated for each Non-Volatile Memory Host Controller Interface can be used to indicate the communication channel assigned to each Non-Volatile Memory Host Controller Interface on the preset connection line.

In some embodiments, the transmission unit 402 can be configured to send at least one of the processor identifier or the communication channel identifier generated for each Non-Volatile Memory Host Controller Interface to the system management unit within the central processor of the electronic device, such that the system management unit generates and outputs the corresponding function number for each Non-Volatile Memory Host Controller Interface according to the at least one of the processor identifier or the communication channel identifier through the preset generation rule.

In some embodiments, when a function number needs to be output for a corresponding target hardware interface, the input data of the second system management module can include the communication channel assignment parameter corresponding to the corresponding target hardware interface, and the output data can include the input communication channel assignment parameter and the determined function number.

The acquisition unit 403 can be configured to, for each target hardware interface, match at least a part of the communication channel assignment parameters generated based on the target operation for the target hardware interface with the output data when the second system management module outputs the function numbers for the target hardware interfaces, and obtain the function number from the output data that matches the at least a part of the communication channel assignment parameters as the function number of the corresponding target hardware interface.

In some embodiments, the apparatus can further includes a hot plugging processing unit, configured to, after obtaining the function numbers output by the second system management module for the target hardware interfaces, respectively, and in response to a hot plugging event for the target hardware at the corresponding target hardware interface, perform the corresponding hot-plug processing on the target hardware based on the identification information of the corresponding target hardware interface.

The identification information of the corresponding target hardware interface can be generated based on the function number of the corresponding target hardware interface.

In some embodiments, the assignment unit 401 can be configured to, during the preset stage of the power-on self-test process of the electronic device, perform the target operation for assigning the communication channels to the target hardware interfaces of the electronic device, respectively.

In some embodiments, the preset stage can be earlier than the Driver Execution Environment (DXE) stage in the power-on self-test process of the electronic device. The apparatus can include a path control unit, configured to, after obtaining the function numbers output by the second system management module for the target hardware interfaces, respectively, during the driver execution environment stage during the power-on self-test process of the electronic device, perform the path controlling on the target hardware interfaces based on the identification information corresponding to the target hardware interfaces. The identification information corresponding to each target hardware interface can be generated based on the function number of the target hardware interface.

In some embodiments, the apparatus can further includes an attribute recognition unit, configured to, before performing the target operation for assigning the communication channels to the target hardware interfaces of the electronic device, respectively, obtain the attributes of the hardware interfaces on the electronic device to trigger the target operation for the target hardware interface having the target attribute.

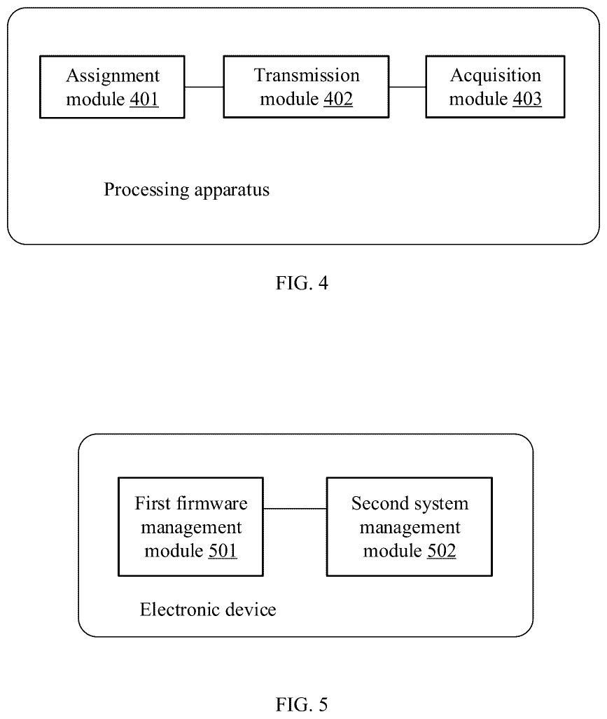

In addition, embodiments of the present disclosure also provide an electronic device. The structure of the electronic device is shown in FIG. 5. The electronic device includes a first firmware management module 501 and a second system management module 502 having the system management function.

In addition, the electronic device further includes, but is not limited to, a processor, memory, graphics card, camera, and other assemblies.

The first firmware management module 501 can be configured to perform the processing method of any above embodiments. Thus, by performing the processing method of embodiments of the present disclosure, the stability of the hot plugging function of the target hardware interface, such as the NVME interface, can be ensured.

Each embodiment in this specification is described in a progressive manner. The key points of each embodiment are the differences from other embodiments, and parts that are the same or similar among the embodiments can be referred to each other.

For ease of description, when describing the above system or apparatus, the modules or units can be described separately according to the functions. Of course, when implementing the present disclosure, the functions of the units can be implemented in one or more pieces of software and/or hardware.

From the above description of embodiments, those skilled in the art can clearly understand that the present disclosure can be implemented by means of software combined with a necessary general hardware platform. Based on such understanding, the technical solution of the present disclosure, in essence, or at least the part that makes a creative contribution, can be embodied in the form of a software product. The computer software product can be stored in a storage medium such as ROM/RAM, disk, optical disk, etc., and include several instructions to allow the computer device (e.g., a personal computer, server, or network device, etc.) to execute the methods described in the embodiments or certain parts of the embodiments of the present disclosure.

Finally, it should be noted that in this document, relational terms such as “first,” “second,” “third,” and “fourth” are used to distinguish one entity or operation from another, and do not necessarily require or imply any such actual relationship or order among the entities or operations. Moreover, the terms “comprise,” “include,” or any variation thereof, are intended to cover non-exclusive inclusion, such that a process, method, article, or device that includes a series of elements, not only includes those elements but also include other elements that are not listed or elements inherit from the process, method, article, or device. When there is no more limitation, an element defined by the phrase “comprising a . . . ” does not exclude the presence of additional identical elements in the process, method, article, or device that includes the element.

The above descriptions are merely some embodiments of the present disclosure. For those skilled in the art, various improvements and modifications can be made without departing from the principles of the present disclosure. These improvements and modifications should also be within the scope of the present disclosure.

What is claimed is:

1. A processing method comprising:
performing, by a first firmware management module, a target operation for assigning communication channels to target hardware interfaces of an electronic device, respectively, to obtain a communication channel assignment parameter generated for each of the target hardware interfaces;
sending, by the first firmware management module, the communication channel assignment parameter generated for each of the target hardware interfaces to a second system management module of the electronic device, so that the second system management module outputs corresponding function numbers for the target hardware interfaces based on corresponding communication channel assignment parameters, respectively; and
obtaining, by the first firmware management module, the function numbers output by the second system management module for the target hardware interfaces, each function number corresponding to a target hardware interface.

2. The processing method according to claim 1, wherein:
the first firmware management module is a unified extensible firmware interface (UEFI) of the electronic device; and
performing, by the first firmware management module, the target operation for assigning the communication channels to the target hardware interfaces of the electronic device, respectively, to obtain the communication channel assignment parameter generated for each of the target hardware interfaces includes:
performing, by the UEFI, the target operation for assigning communication channels to non-volatile memory host controller (NVME) interfaces of the electronic device to obtain at least one of a processor identifier or communication channel identifier generated for each NVME interface;
wherein:
the processor identifier generated for each NVME interface is used to indicate a processor connected to each NVME interface via the assigned communication channel;
the target operation is used to assign the communication channels to the NVME interfaces on a preset connection line; and
the communication channel identifier generated for each NVME interface is used to indicate a communication channel assigned to each NVME interface on the preset connection line.

3. The processing method according to claim 2, wherein sending, by the first firmware management module, the communication channel assignment parameter generated for each of the target hardware interfaces to the second system management module of the electronic device, so that the second system management module outputs the corresponding function numbers for the target hardware interfaces based on the corresponding communication channel assignment parameters, respectively, includes:
sending, by the UEFI, at least one of the processor identifier or the communication channel identifier generated for each NVME interface to a system management unit (SMU) in a central processor of the electronic device, so that the SMU generates and outputs a corresponding function number for a root port of each NVME interface according to the at least one of the corresponding processor identifier or the communication channel identifier through a preset generation rule.

4. The processing method according to claim 1, wherein:
when a function number needs to be output for a corresponding target hardware interface, input data of the second system management module includes the communication channel assignment parameter corresponding to the corresponding target hardware interface, and output data includes the input communication channel assignment parameter and the determined function number; and
obtaining, by the first firmware management module, the function numbers output by the second system management module for the target hardware interfaces includes:
for each target hardware interface, matching, by the first firmware management module, at least a part of the communication channel assignment parameters generated based on the target operation for the target hardware interface with the output data when the second system management module outputs the function number for the target hardware interfaces; and
obtaining, by the first firmware management module, the function number in the output data that matches the at least a part of the communication channel assignment parameters as the function number of the target hardware interface.

5. The processing method according to claim 1, further comprising, after the first firmware management module obtains the function numbers output by the second system management module for the target hardware interfaces, respectively:
in response to a hot plugging event occurring for target hardware at the corresponding target hardware interface, performing, by the first firmware management module, corresponding hot plugging processing on the target hardware based on identification information of the corresponding target hardware interface;
wherein, the identification information of the corresponding target hardware interface is generated based on the function number of the corresponding target hardware interface.

6. The processing method according to claim 1, wherein performing, by the first firmware management module, the target operation for assigning the communication channels to the target hardware interfaces of the electronic device includes:
performing, by the first firmware management module, the target operation for assigning the communication channels to the target hardware interface of the electronic device during a preset stage of a power-on self-test process of the electronic device.

7. The processing method according to claim 6,
wherein the preset stage is before a driver execution environment (DXE) stage of the power-on self-test process of the electronic device;
the method further comprising, after the first firmware management module obtains the function numbers output by the second system management module for the target hardware interfaces, respectively:
performing path control on the target hardware interfaces based on the corresponding identification information of the target hardware interfaces in the DXE state of the power-one self-test process of the electronic device;
wherein the identification information corresponding to each target hardware interface is generated based on the function number of the target hardware interface.

8. The processing method according to claim 1, further comprising, before the first firmware management module performs the target operation for assigning the communication channels to the target hardware interfaces of the electronic device, respectively:
obtaining, by the first firmware management module, attributes of the hardware interfaces of the electronic device to trigger the target operation for a target hardware interface having a target attribute.

9. A processing apparatus comprising:
an assignment unit configured to perform a target operation for assigning communication channels to target hardware interfaces of an electronic device, respectively, to obtain a communication channel assignment parameter generated for each of the target hardware interfaces;
a transmission unit configured to send the communication channel assignment parameter generated for each of the target hardware interfaces to a second system management module of the electronic device, so that the second system management module outputs corresponding function numbers for the target hardware interfaces based on corresponding communication channel assignment parameters, respectively; and
an acquisition unit configured to obtain the function numbers output by the second system management module for the target hardware interfaces, each function number corresponding to a target hardware interface.

10. An electronic device comprising:
a first firmware management module configured to provide an interface between an operating system of the electronic device and hardware; and
a second system management module having a system management function;
wherein the first firmware management module is further configured to:
perform a target operation for assigning communication channels to target hardware interfaces of an electronic device, respectively, to obtain a communication channel assignment parameter generated for each of the target hardware interfaces;
send the communication channel assignment parameter generated for each of the target hardware interfaces to a second system management module of the electronic device, so that the second system management module outputs corresponding function numbers for the target hardware interfaces based on corresponding communication channel assignment parameters, respectively; and
obtain the function numbers output by the second system management module for the target hardware interfaces, each function number corresponding to a target hardware interface.

11. The electronic device according to claim 10, wherein:
the first firmware management module is a unified extensible firmware interface (UEFI) of the electronic device; and
the UEFI is configured to perform the target operation for assigning communication channels to non-volatile memory host controller (NVME) interfaces of the electronic device to obtain at least one of a processor identifier or communication channel identifier generated for each NVME interface;
wherein:
the processor identifier generated for each NVME interface is used to indicate a processor connected to each NVME interface via the assigned communication channel;
the target operation is used to assign the communication channels to the NVME interfaces on a preset connection line; and
the communication channel identifier generated for each NVME interface is used to indicate a communication channel assigned to each NVME interface on the preset connection line.

12. The electronic device according to claim 11, wherein the UEFI is further configured to:
sending at least one of the processor identifier or the communication channel identifier generated for each NVME interface to a system management unit (SMU) in a central processor of the electronic device, so that the SMU generates and outputs a corresponding function number for a root port of each NVME interface according to the at least one of the corresponding processor identifier or the communication channel identifier through a preset generation rule.

13. The electronic device according to claim 10, wherein:
when a function number needs to be output for a corresponding target hardware interface, input data of the second system management module includes the communication channel assignment parameter corresponding to the corresponding target hardware interface, and output data includes the input communication channel assignment parameter and the determined function number; and
the first firmware management module is further configured to:
for each target hardware interface, match at least a part of the communication channel assignment parameters generated based on the target operation for the target hardware interface with the output data when the second system management module outputs the function number for the target hardware interfaces; and
obtain the function number in the output data that matches the at least a part of the communication channel assignment parameters as the function number of the target hardware interface.

14. The electronic device according to claim 11, wherein the first firmware management module is further configured to:
in response to a hot plugging event occurring for target hardware at the corresponding target hardware interface, perform corresponding hot plugging processing on the target hardware based on identification information of the corresponding target hardware interface;
wherein, the identification information of the corresponding target hardware interface is generated based on the function number of the corresponding target hardware interface.

15. The electronic device according to claim 10, wherein the first firmware management module is further configured to:
perform the target operation for assigning the communication channels to the target hardware interface of the electronic device during a preset stage of a power-on self-test process of the electronic device.

16. The electronic device according to claim 15, wherein:
the preset stage is before a driver execution environment (DXE) stage of the power-on self-test process of the electronic device; and
the first firmware management module is further configured to:
perform path control on the target hardware interfaces based on the corresponding identification information of the target hardware interfaces in the DXE state of the power-one self-test process of the electronic device;
wherein the identification information corresponding to each target hardware interface is generated based on the function number of the target hardware interface.

17. The electronic device according to claim 10, wherein, before performing the target operation for assigning the communication channels to the target hardware interfaces of the electronic device, respectively, the first firmware management module is further configured to:
obtain attributes of the hardware interfaces of the electronic device to trigger the target operation for a target hardware interface having a target attribute.
